(19) United States
(12) Patent Application Publication
(10) Pub. No.: US 2002/0038217 A1
(43) Pub. Date: Mar. 28, 2002

(54) System and method for integrated data analysis and management

(76) Inventor: Alan Young, Mount Sinai, NY (US)

Correspondence Address: Arter & Hadden LLP, One Columbus, Suite 2100, 10 West Broad Street, Columbus, OH, 43215-3422, US

(21) Appl. No.: 09/829,151

(22) Filed: Apr. 9, 2001

Related U.S. Application Data
(60) Provisional application No. 60/195,851, filed on Apr. 7, 2000.

(51) Int. Cl. G06F 17/60

(52) U.S. Cl. 705/1

(57) ABSTRACT

A method for analyzing business data is described. The method includes the steps of identifying a key performance indicator and identifying at least one business event associated with the key performance indicator. The method further includes the step of receiving a business event message including business data describing the business event. The method also includes the step of processing the business data to determine the value of at the key performance indicator, The determined value of the key performance indicator is transmitted to a contextual visualization interface for presentation to a user. A system for analyzing and presenting business data is also described. The system includes a contextual visualization interface and a workflow manager. The workflow manager is in communication with the contextual visualization interface, and is further in communication with at least one application. The workflow manager is operative to receive event data from the application, and the contextual visualization interface is operative to present business information to a user.

### CROSS-REFERENCE TO RELATED APPLICATION

This application claims priority to U.S. Provisional Application Serial No. 60/195,851 filed Apr. 7, 2000 which is incorporated by reference in its entirety, herein.

### TECHNICAL FIELD

The described system and method are generally related to software-implemented methods, systems and articles of manufacture for analyzing, managing and presenting business solutions. More specifically, the described system and method are related to systems and methods for analyzing, managing and presenting business information from a variety of disparate sources.

### BACKGROUND

Prior art business management software is largely directed to Enterprise Application Integration (EAI). These prior art solutions are directed toward the problems of integrating business data and processes stored on and performed by various systems throughout an organization. Prior art business management applications are typically designed to tie together many diverse systems. Although some such applications provide reporting functions, none of the prior art business management applications provide automated in-depth analysis of the integrated business data. Further, there is a need for business management software that provides predictive reporting and problem resolution.

Consequently, a need exists for an improved method and system for reorganizing data that enables a reorganization utility to operate more efficiently than conventional reorganization utilities. Specifically, a need exists for methods and systems for analyzing, managing and presenting business information from a variety of disparate sources.

### SUMMARY

A method for analyzing business data is described. The method includes the steps of identifying a key performance indicator and identifying at least one business event related to the key performance indicator. The method further includes the step of receiving a business event message including business data describing the business event. The business data is processed to determine the value of the key performance indicator, the determined value is transmitted to a contextual visualization interface for presentation to a user.

A system for analyzing and presenting business data is also described. The system includes a contextual visualization interface. The contextual visualization interface is operative to present business information in a context defined by a plurality of key performance indicators and business events. The system also includes a workflow manager in communication with the contextual visualization interface. The workflow manager is operative to define and report the plurality of key performance indicators, and identify and report business events. The workflow manager is in communication with at least one application and is further operative to receive business event data from the application

The objects, features and advantages of the disclosed method and system are readily apparent from the following description of the preferred embodiments when taken in connection with the accompanying drawings.

### BRIEF DESCRIPTION OF THE DRAWINGS

For a more complete understanding of the disclosed method and system and the advantages thereof, reference is now made to the following description taken in conjunction with the accompanying drawings in which like reference numbers indicate like features and wherein:

FIG. 1 is a schematic block diagram illustrating the architecture of an embodiment of the described system;

FIG. 2 is a schematic block diagram illustrating certain components of the workflow manager of FIG. 1; and

FIG. 3 is a functional flow diagram illustrating the primary steps of an embodiment of the described method for presenting information in a visual context; and

FIGS. 4-6 are computer screen displays illustrating exemplary output of the described contextual visualization interface.

### DETAILED DESCRIPTION

Architecture Overview

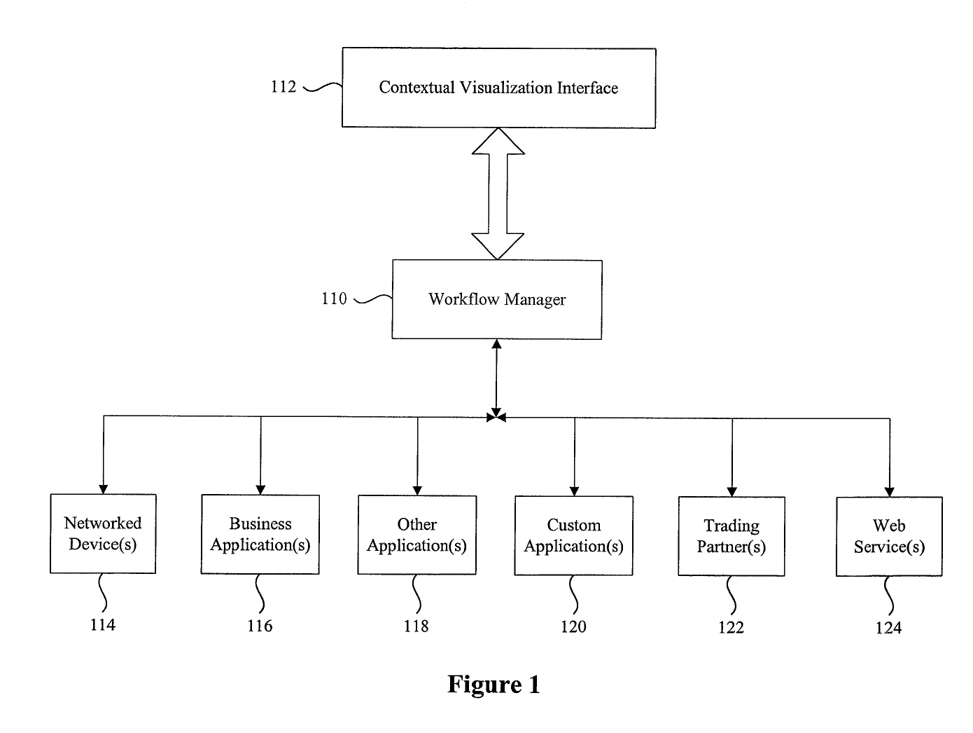

The disclosed methods of analyzing and managing business data preferably operate in a system having an architecture such as that illustrated in FIG. 1. As shown, the system 100 includes a workflow manager 110 that is responsible for collecting data from several disparate data sources, analyzing the collected information and presenting the results to a user via a contextual visualization interface 112. Workflow manager 110 may be employed to provide a number of business solutions related to, for example, supply chain management, manufacturing optimization, distribution and warehousing. The relevant business data is collected from other sources in a number of ways, including for example via a global computer network 112, such as the Internet, via a wide area network (WAN) or local area networks (LAN) connection, via batch processing and via a human operator.

Workflow manager 110 is preferably installed on a local business computer or network, and it enables the definition of key performance indicators relating to the business data in which the company is interested. Workflow manager 110 further enables business processes to be managed according to exception rules. Workflow manager 110 also supports event identification, event correlation and event prediction based on historical parameters and user-defined parameters.

As shown, networked devices 114 may provide data to workflow manager 110, such as statistics describing equipment use, maintenance alerts and equipment status, for example. Business applications 116 provide business data to workflow manager 110. Other standardized applications 118 and customized applications 120 also provide data to workflow manager 110, such as, for example, e-mail data, voicemail data, and custom manufacturing data. Workflow manager 110 further receives information from a variety of defined trading partners 122. These trading partners may include customers, suppliers, distributors, and other remote business computers located throughout the enterprise. In certain situations, workflow manager 110 may receive information from a variety of web services 124. Such web services 124 may provide any type of data that may be located on-line, such as for example, commodities data, stock data, news data, and weather data.

The information provided by web services 124 will are processed by workflow manager 110 to depict current business conditions and predict future business conditions, such as the effects of the supply chains between the business and its suppliers and between the business and its customers, for example. Such current and future conditions are then processed with respect to Key Performance Indicators to present a contextual perspective of the business conditions, and provide alerts and/or warnings, as appropriate.

Contextual Visualization Interface

Contextual visualization interface 112 enables a user to view various aspects of the a business. The visualization management service provides a lower level management capability aimed at audiences where a bigger management and status picture is required. In a preferred embodiment, it utilizes the Unicenter TNG WorldView interface developed by Computer Associates International, Inc. with a business object model that implements Business Process Views (BPV's) representing the different aspects of an enterprise such as manufacturing, finance and human resources, for example. Preferably, the business object model is an extensible object model that implements both line-of-business visualization object definitions and application-level data object definitions.

Preferably, the display techniques employed by the contextual visualization interface 112 are consistent with those described by U.S. Pat. No. 5,958,012 entitled “Network Management System using Virtual Reality Techniques to Display and Simulate Navigation to Network Components”, U.S. Ser. No. 09/408,213 entitled “Network Management System using Virtual Reality Techniques to Display and Simulate Navigation to Network Components,” U.S. Ser. No. 09,558,897 entitled “Method and Apparatus for Predictively and Graphically Administering a Networked System in a Time Dimension” and U.S. Ser. No. 09/545,024 entitled “Method and Apparatus For Intuitively Administering Networked Computer Systems.” The contents of U.S. Pat. No. 5,958,012, and U.S. Ser. Nos. 09/408,213, 09,558,897, and 09/545,024 are hereby incorporated by reference in their entireties.

Workflow Manager

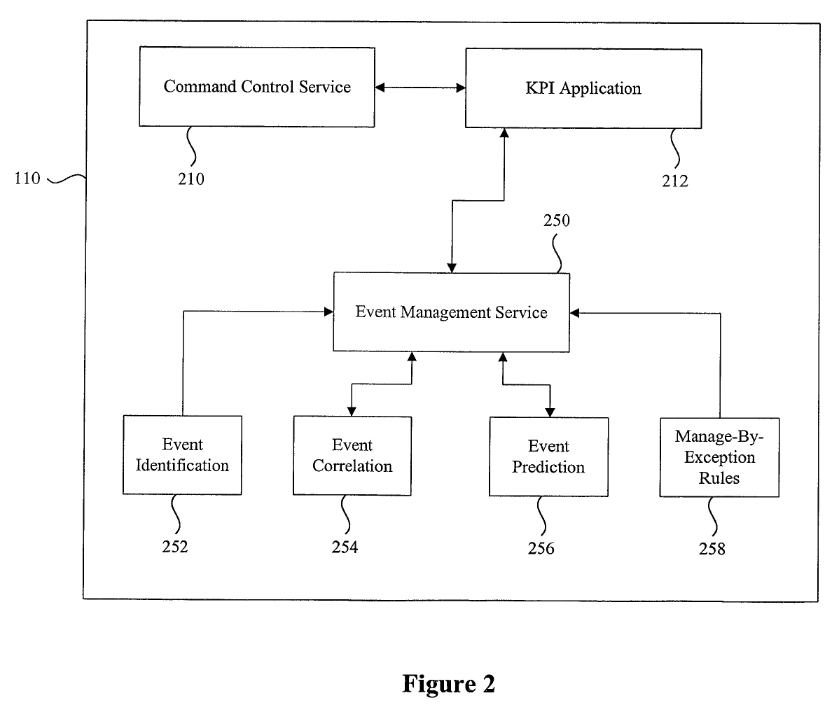

Referring now to FIG. 2, certain components of workflow manager 110 are illustrated. As shown, workflow manager 110 is comprised of several components, including a command control service 210, and an event management service 250.

The workflow manager enables automated business processes that:

Span hardware computing platforms;

Span operating systems;

Provide for integration of other applications through adapters;

Provide for integration of other processes in other organizations through XML or industry standard workflow interoperability support (such as WFMC Interface 4, for example);

Integrate tightly with a contextual visualization interface for unprecedented management, monitoring, and visualization capabilities.

Preferrably, workflow support is for business processes executing under the control of and within a single server. Each running workflow server has a tight integration with a specific business application that allows workflows to be triggered and synchronized based on application activity, and to “control” the application by invoking application screens. This includes support for remote workflow invocation and co-ordination. It is possible to start workflows remotely, such as on other nodes. It is further possible to be able to get state information for the remote workflows, and to co-ordinate activity between different workflows such as, for example, waiting for a remote workflow to complete before proceeding. The model for doing this is a “coach-player” scenario with a designated workflow server node controlling the main business process. This “coach” node instructs other “player” nodes of sub-processes to perform while monitoring their progress and controlling the overall process.

The workflow manager includes a reliable messaging mechanism for communicating workflow information across disparate nodes. This consists of a protocol sufficient to communicate workflow identification, status, and input and output parameters, described below.

The command control service 210 enables command level management where business information can be summarized and localized to a specific line of business for high-level audiences. This service uses Key Performance Indicator (“KPI”) applications 212 to allow high-level users to visualize and implement high-level policy directed toward monitoring their specific interests and needs.

In the preferred embodiment, KPI wizards are provided to enable a KPI application to be developed. The KPI wizards allow the selection of discrete or aggregated object values to be visualized and monitored. KPI applications depend on the event management service 250. The policies defined in the event management service component determine what is presented to a high level user and what the user can do to affect a particular situation.

For example, a KPI application that visualizes a data point defined as the “Total Gross Profit Before Taxes” might have more than one event policy associating it to sales orders, manufacturing orders and purchase orders. This means that any negative or positive event with respect to any of these order types can be directly correlated as affecting the “Total Profit” and therefore enforce a certain visualization policy as well as providing specific value information, such as how much the profit will be affected, for example.

Data points in a KPI application are subject to business policy definitions. This is the link between the command control service and the multi-source information flowing through the system infrastructure.

The KPI Application includes a KPI wizard which presents business data currently available to the infrastructure and allows the definition of the KPI application. This definition is preferably stored as an object in the database and thus also available to higher-level applications monitoring change within this object. The KPI Application further includes a KPI Status Update Service which is a CLI-based tool for use with Event/Aion business policies for communicating status and status description information associated with the interface. This allows for real-time event notification or alert.

The event management service 250 supports business policy definition as well as business event generation services. It includes capabilities for defining business policies, publishing business events and translating business events, among other capabilities.

Business policies are defined using native event and Aion Information Management and Correlation Engines. This capability extends to being able to implement visual policy, rules-based management, access additional information available through the infrastructure (from any information provider), generate new events and interact with existing application services.

Business event identification and publication may be implemented in a number of ways such that new business event information is incorporated into the information flow within the infrastructure. One significant purpose for some events is to allow them to be used in business policy definitions within the event and aion correlation engines. Examples of event publication means include:

Event Listeners—This wizard-driven tool enables a user to identify events to be “listened” for. Such events may affect any object and in turn generate event messages for further policy application.

Application Events Services—This facility supports events generated through API and CLI-level interfaces, and allows information from applications to flow into the infrastructure. These services can be used as an additional event definition outside the scope of a wrapper, as a replacement of event services that may not be available in a wrapper, or for those applications that do not have a wrapper. These events may also be generated as objects in the infrastructure where they can be further utilized by any subscribed application.

Business Intelligence Event Services—This facility supports events generated through API/CLI interfaces which are intended primarily for “external” information sources (although internal knowledge modules feeding on flowing information can generate their own intelligence events) such as web-crawlers and other more sophisticated solutions implementing natural-language-processing and semantic analysis, for example. These events are also generated as objects in the infrastructure where they can be further utilized by any subscribed application. Business event translation services include:

XML Translators—any application-level or intelligence-level event created will be translated to XML format making it available to any XML-enabled application.

XML Parsers—any application-level or intelligence-level event generated can be parsed, and available in its entirety or in its individual components to any XML enabled application or policy.

Event management service 250 also utilizes manage-by-exception rules 258. These rules may be used, for example, to describe Just-In-time (“JIT”) discovery services and to implement visual management-by-exception. This API/CLI driven service can be used to automatically discover and populate the World View (Visualization area) interface. Specific object status information is available for further in-context management and application launch.

An event correlation service 254 is also utilized by the event management service 250. Among other functions, it provides an alarm service to be incorporated in terms of business policies to define when a particular event message should reach the console or is expected. The correlation service will monitor its expected message queue and will generate a business event notification when the message arrives to the console or when the expected time has been reached without arrival (signifying that the expected message is late).

Business Events

A business event is a message between an information source and the workflow manager describing a significant business activity. Preferably, business event policies should have enough information to be able to establish a secondary, 2-way communication with an appropriate information source to obtain additional or related information about objects involved in the business event.

The format for a business event should identify, describe, and detail provisions about the event being reported. The nature of any particular event could be object, business process, or intelligence (fact) levels. The information should allow the management policy to obtain further information from the event provider, if possible and if necessary.

A distinct and different specification is made for the intelligence business events. This to provides neutrality with respect to the object definitions from the source entity and provides support for the sharing of this information for non-object oriented purposes.

An information provider that supports event notification must support at least one event class. Typically, such a provider would support at least the following:

ObjectCreatedEvent—a new object has been created in the namespace

ObjectChangedEvent—an existing object has been modified in the namespace

ObjectDestroyedEvent—an object has been destroyed in the namespace

Business events can be generated through the use of APIs and CLIs as well as through intelligent agents or bots. Preferably, these utilities support XML and generate the event in the XML format regardless of the format of the original information passed. This allows for the support for non-XML enabled applications.

Management policies should have the ability to parse and understand each event. They similarly should have the ability to request additional information about the event back to the provider. For example, if an event regarding a problematic manufacturing process for part number 12345 is generated, the management policy might need to reference more information regarding what other business processes are affected by this situation—e.g. are there any sales orders or manufacturing orders depending on this part?.

Regardless of their format, business event messages can take advantage of native management services within the system. This includes action policy defined within the business event manager component as well as the Aion rules-based management system. Complementary and providing an even higher type of management benefit, business event information can be used to feed real-time information to neural agents implementing business process management.

Both the event manager and Aion can cooperate to implement very complex and yet efficient business policies designed to deal with events and business processes. These services allow for the chaining of disparate management systems such as, for example, supply chain, financial or manufacturing as appropriate.

One function of the event manager service 250 is to serve as a general-purpose “alarm” utility that can be used to generate notifications at a specified point in time. While this utility is primarily used in conjunction with the workflow engine, it could be applied to other applications in which time keeping is needed.

The event timer is able to receive an event message that is formatted to specify the sender, the nature of the message, a successor event and what the expected time period should be for this successor event to occur. This information will be stored in the timer's memory.

The timer's database is examined at regular intervals, preferably configurable at service startup time, and when a time cycle has been reached for a certain event, a message is generated in the console indicating that the successor event is now overdue and the event is purged from memory. Typically, the message will be remain in the timer's memory until the event timer receives an event specifically instructing the deletion or a message indicating that the successor event has occurred.

The underlying event store and search capabilities should be such that it will provide optimized access to the event information. Preferably, each event and its associated information represent a node in an AVL tree with a key field being the successor time in long format.

The timer provides API and CLI level interfaces which allow for a string input and perform a conversion to a long value representing the number of seconds difference between the given date and the date 10:01:99:12:00:00. Suggested time format is MM:DD:YY:HH:MM:SS.

Web Bots

One aspect of the present system is the availability of intelligent agents to provide ongoing business information and events to the workflow manager. The intelligent agent of the present system is more than the low-level “bot” used on the Internet. The typical bot is an entity that functions as a mini web browser accessing and generating information based on Internet intelligence sources such as, for example, news, weather and financials. The typical sophistication extends to different levels such as “spider bots”, those used by the search engine to continually crawl and index the Internet world in order to provide a pre-discovered and pre-indexed data compilation that search engines can then mine. The intelligent agents of the present system implement a higher level of capabilities including correlation, pattern recognition and fuzzy logic, for example.

The intelligent agents of the present system have an even higher level of sophistication in that they also provide intelligent interfaces that leverage the system infrastructure to be able to mine information flow in a natural-language semantic fashion and generate a variety of different business intelligence events that are provided to the workflow manager, thereby feeding the inference and predictive technology of the workflow manager. This combination of simple event-driven information with business application intelligence distinguish the intelligent agents of the present invention from those presently in use on the Internet.

Of course, the intelligent agents also adhere to the unofficial code of ethic that governs the entire concept of web bots, spiders, and intelligent agents. This includes consideration to traffic and overhead impositions on the information sources, proper identification techniques, and the legal use of the found information.

Using inference, prediction and pattern analysis, the present intelligent agents provide sufficient semantic information for business policies to be able to answer simple why, when and how questions, such as “Tell me when a bankruptcy occurs”, “Tell me how the SMITH and JONES companies relate.” and “Tell me why the revenues of the plastic manufacturing market are declining.”

According to one embodiment, the intelligent agents support several types of business intelligence, including:

Reference Events—Events that are fundamentally discrete, such as bankruptcy, mergers, acquisitions, weather forecasts, traffic forecasts, for example.

Change Events—Events that require prior intelligence with respect to a subject, such as a change in pricing, or a change in stock price, for example.

Threshold Events—Events that require correlation with respect to prior knowledge, such as a stock price falling below $100 per share, for example.

Task Completion Events—Events that report a business process, such as when financial disclosure data has been uploaded, for example.

Task Failure Events—Events that report a business process failure, such as when financial disclosure data has been uploaded, for example.

Another high-level aspect of the preferred intelligent agents is that all of these event types are aggregated through a business policy definition. This provides comprehensive command and control capabilities to users by applying this intelligence in the context of specific applications and data. In addition, the intelligent agents provide subscription services for all defined event types in order for applications and policies to specify their requests for information.

The techniques for controlling the present intelligent agents may include those described in U.S. Ser. No. 09/084,620, entitled “Method and Apparatus for System State Monitoring using Pattern Recognition and Neural Networks”, filed May 26, 1998, the entire contents of which is hereby incorporated by reference.

A specific implementation of such intelligent agents is a weather wrapper service. This wrapper hides the particular issues of how the weather data is accessed and requested and provides a common interface for the business policy engine as well as the interfaces that need weather-related information as part of the decision-making process.

The weather wrapper provides information to satisfy discrete rules, such as “what is the temperature in Atlanta, Ga.?”, for example. The weather wrapper also provides information to satisfy declarative rules such as “Is it cold in Atlanta, Ga.?”, for example. Of course, the definition of “cold” is subject to business policy rules, as well.

The preferred weather wrapper utilizes an object model. Weather objects have an association with location at any scale supported by the underlying information service such as hemisphere-wide, continent-wide, country wide, state wide or city wide for example.

The preferred weather wrapper includes the following methods:

CurrentWeather(city)—provides current weather forecast for indicated city. Result adheres to a predefined list of possible values.

ForecastWeather(city)—provides forecast (1 day, 2 day, etc.) weather for indicated city.

CurrentTemperature(city)

LowTemperature(city)

HighTemperature(city)

In addition, the preferred weather wrapper includes intelligent information management based on underlying information source. Specifically, the wrapper will implement the decision making process to decide whether existing (i.e. cached) data should be used or whether new data should be requested.

Process Overview

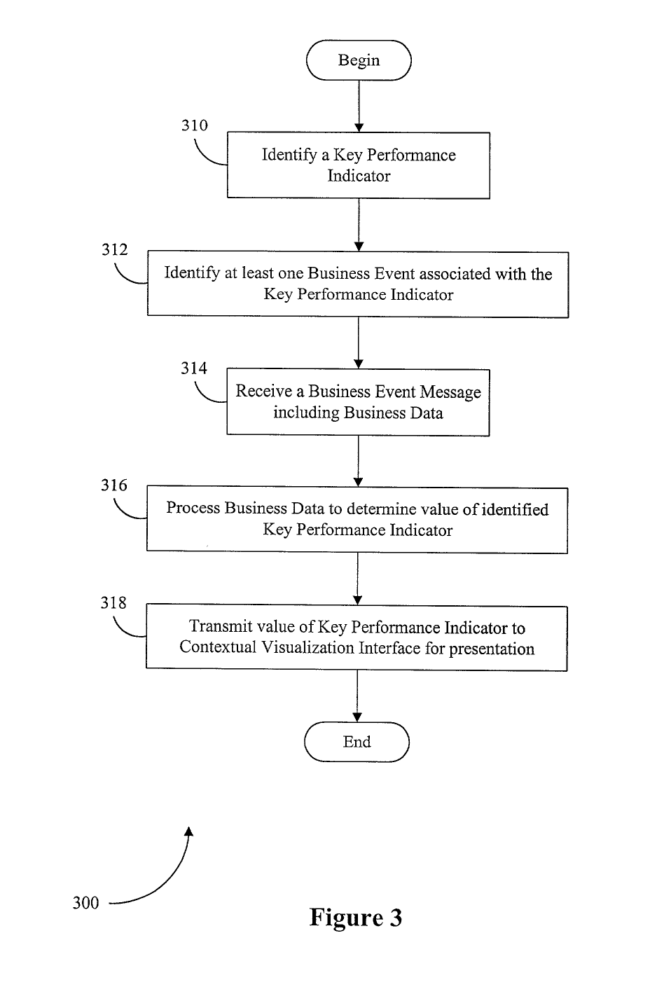

Referring now to FIG. 3, the steps of an embodiment of the disclosed method for analyzing and presenting business data are depicted. At step 310, a key performance indicator is identified. Typically, key performance indicators will be identified through user input, however, key performance indicators may be input electronically using historical performance data or projected performance data. At step 312, at least one business event is identified. Specific business events may be based on the management objectives of the user and may be based on historical or projected business events necessary to accomplish a particular business function.

At step 314, a business event message is received by the workflow manager. This indicates that a business event has occurred, and business data related to the event is transmitted as part of the business event message. At step 316, the business data is analyzed to determine the value of the identified key performance indicator. The determined value is provided to a contextual visualization interface at step 318 for presentation to the user.

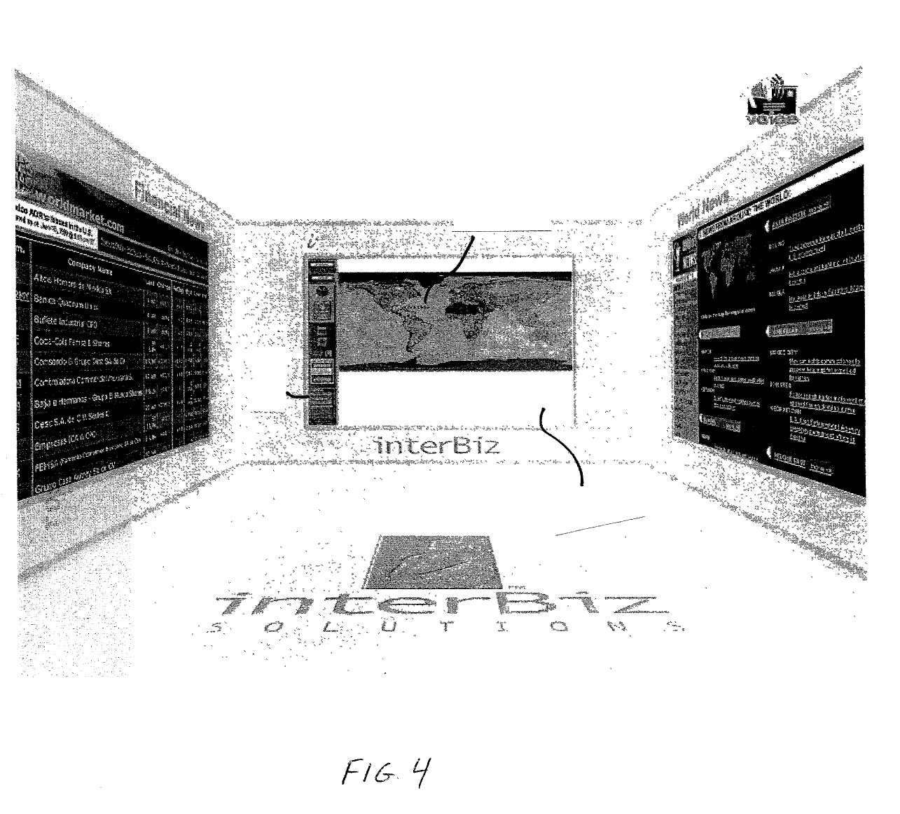

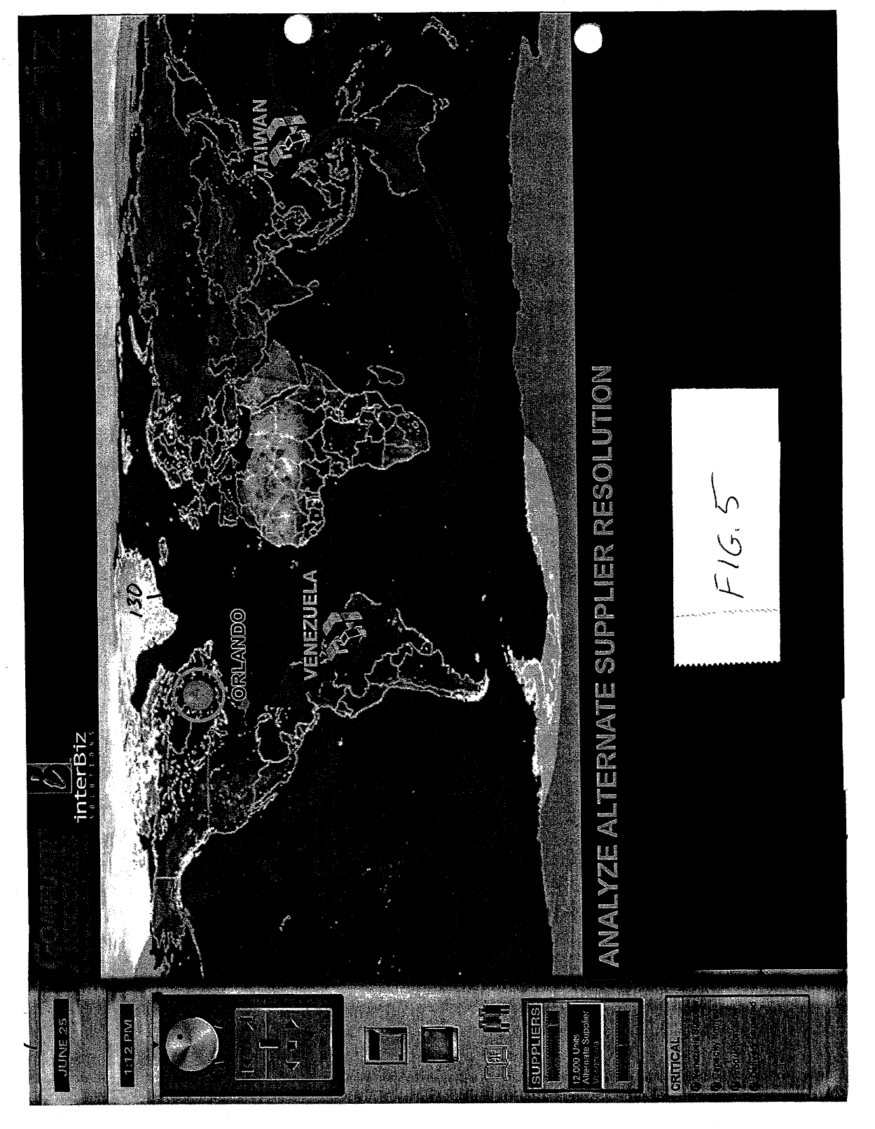

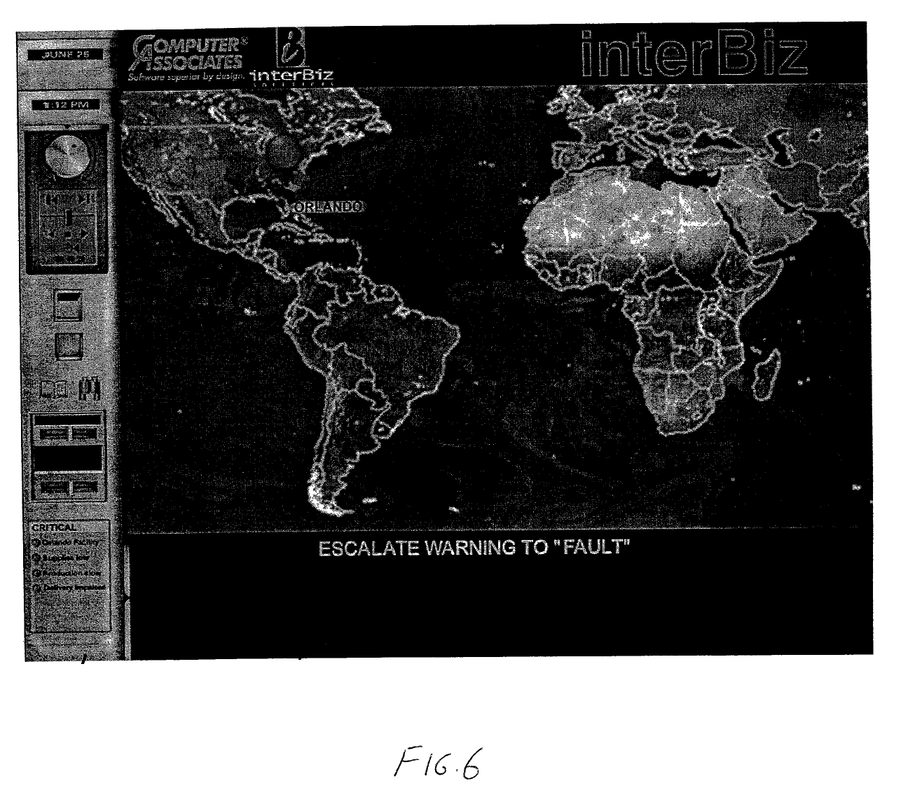

FIGS. 4, 5 and 6 illustrate examples of screen displays that may be utilized by the contextual visualization interface.

From the above description, those skilled in the art will perceive improvements, changes and modifications in the disclosed method and system. Such improvements, changes and modifications within the skill of the art are intended to be covered by the appended claims.

Accordingly, it is to be understood that the drawings and description in this disclosure are proffered to facilitate comprehension of the disclosed method and system, and should not be construed to limit the scope thereof. It should be understood that various changes, substitutions and alterations can be made without departing from the spirit and scope of the disclosed method and system as defined solely by the appended claims.

What is claimed is:

1. A method for analyzing business data, comprising:
identifying a key performance indicator;
identifying at least one business event associated with the key performance indicator;
receiving a business event message including business data describing the business event;
processing the business data to determine the value of at the key performance indicator; and
transmitting the determined value of the key performance indicator to a contextual visualization interface for presentation to a user.

2. A method according to claim 1, wherein the business event message represents a reference event.

3. A method according to claim 1, wherein the business event message represents a change event.

4. A method according to claim 1, wherein the business event message represents a threshold event.

5. A method according to claim 1, wherein the business event message represents a task completion event.

6. A method according to claim 1, wherein the business event message represents a task failure event.

7. A method according to claim 1, wherein the key performance indicator is a prediction, and the step of processing includes applying predictive logic to the business data.

8. A system for analyzing and presenting business data, comprising:
a contextual visualization interface operative to present business information in a context defined by a plurality of key performance indicators and events;
a workflow manager in communication with the contextual visualization interface and operative to define and report the plurality of key performance indicators, and identify and report events;
the workflow manager further in communication with at least one application and further operative to receive event data from the application.
